(19) United States
(12) Patent Application Publication
(10) Pub. No.: US 2004/0095254 A1
(43) Pub. Date: May 20, 2004

(54) Door bell answering system

(76) Inventor: Douglas D. Maruszczak, Munster, IN (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/669,100

(22) Filed: Sep. 22, 2003

Related U.S. Application Data
(60) Provisional application No. 60/412,529, filed on Sep. 20, 2002.
(60) Provisional application No. 60/447,834, filed on Feb. 14, 2003.

(51) Int. Cl. G08B 25/08

(52) U.S. Cl. 340/692

(57) ABSTRACT

A doorbell answering system includes is sensor to sense the presence of a visitor at an exterior panel. The system announces a message greeting to the visitor, asking the visitor to identify themselves. The visitor's response is recorded by the exterior panel and played at an interior panel, allowing a resident to monitor the visitor's response. The interior panel also records the visitor's response for subsequent playback in a controlled manner via a control panel. The system may store multiple visitor messages, each identified by a date and time. During monitoring, the resident may open the door, ignore the visitor, or initiate a warning alarm, via two buttons provided at the interior panel. The resident may depress the two buttons, thereby sending a signal to the exterior panel to announce the warning alarm. In an example, the warning alarm is loud enough to cover an area, such as a neighborhood block, to ward off the visitor. The system also includes a safety light that may be activated when the sensor senses the visitor, to offer further protection to the resident.

### CROSS-REFERENCE TO RELATED APPLICATIONS

This application claims the benefit of U.S. Provisional Application No. 60/412,529, filed Sep. 20, 2002.

### FIELD OF THE INVENTION

The invention generally relates to building entry systems and, more particularly, to building entry systems controllable by a resident.

### BACKGROUND OF THE RELATED ART

Houses commonly have some type of doorbell system to announce a visitor. Apartment buildings often use an intercom system for the same purpose. While these systems are commonplace, they present problems to residents. When a resident is away, at work or on vacation, for example, there is no simple way of recording the fact that visitors have stopped by. Although the visitors are no longer there, the resident may still benefit from knowing who stopped by, when, and the nature of their visit. Furthermore, when the resident is home, the resident has no way of polling the visitor for information on the nature of their visit, without first evidencing to the visitor that the resident is home. For example, for an intercom system to work, the resident has to answer the telephone, thereby advising the visitor that they are indeed home. Even in systems where a resident can monitor a visitor, such as by camera, the resident is unable to find out the exact nature of the visitation without divulging their presence.

Further still, even if charged with information regarding the visitor and the nature of the visit, there is nothing the resident can do to ward off unwanted visitations. The resident must simply wait for the visitor to leave. This may not be bothersome to some, but to many residents—the elderly, single women, children home alone, the infirmed, the physically or mentally disabled—maintaining privacy and warding off the unwelcome can be important.

Some door answering systems are available that utilize telephone lines to advise a resident of a visitor. These devices are undesirably complex and can involve costly installation expense. Another problem is that the resident must be at or near a telephone to interact with the system. A further problem is that the resident may not be able to discern the difference between a signal initiated by a visitor at a doorbell and a caller dialing the resident's telephone number. The resident may also be prevented from using both the telephone and the doorbell system at the same time.

Another system uses wireless connections between an exterior unit and an interior unit to communicate messages back and forth. The system is difficult to operate for many in that it uses speech synthesis to control operation. Speech synthesis may be impractical for many residents, such as young children and people that speak only a foreign language. Furthermore, operation is counterintuitive, as there is no simple way to operate the system. Also, there is no technique for storing messages from multiple visitors. Thus, while the system may allow a resident to screen a visitor, the system does not allow the resident to screen a visitor and also record information each time a visitor is screened. The system also provides no way for the resident to ward off unwelcome visitors. Other known systems allow for the storage of multiple messages, but also fail to allow the resident to ward off the unwelcome.

### BRIEF DESCRIPTION OF THE DRAWINGS

FIG. 1 illustrates an exterior panel and interior panel that may be used in a doorbell answering system.

FIG. 2 is a detailed diagram of an example exterior panel.

FIG. 3 is a detailed diagram of another example exterior panel.

FIG. 4 is a detailed diagram of an example implementation of the interior panel of FIG. 1

### DETAILED DESCRIPTION OF THE PREFERRED EMBODIMENT

Numerous examples are provided of a doorbell answering system that may replace or enhance an existing doorbell system. In some examples, the system provides a greeting to a visitor, polling the visitor to identify themselves. The system may present the visitor with a greeting stating: “We are not available to answer the door at this time. Please state the nature of your visit. We will try to get back to you as soon as we can. Thank you.” The system may monitor and record the visitor's response. The systems may be used in residential and other environments to make residents more secure and to make it more convenient for those who cannot or do not wish to answer a door.

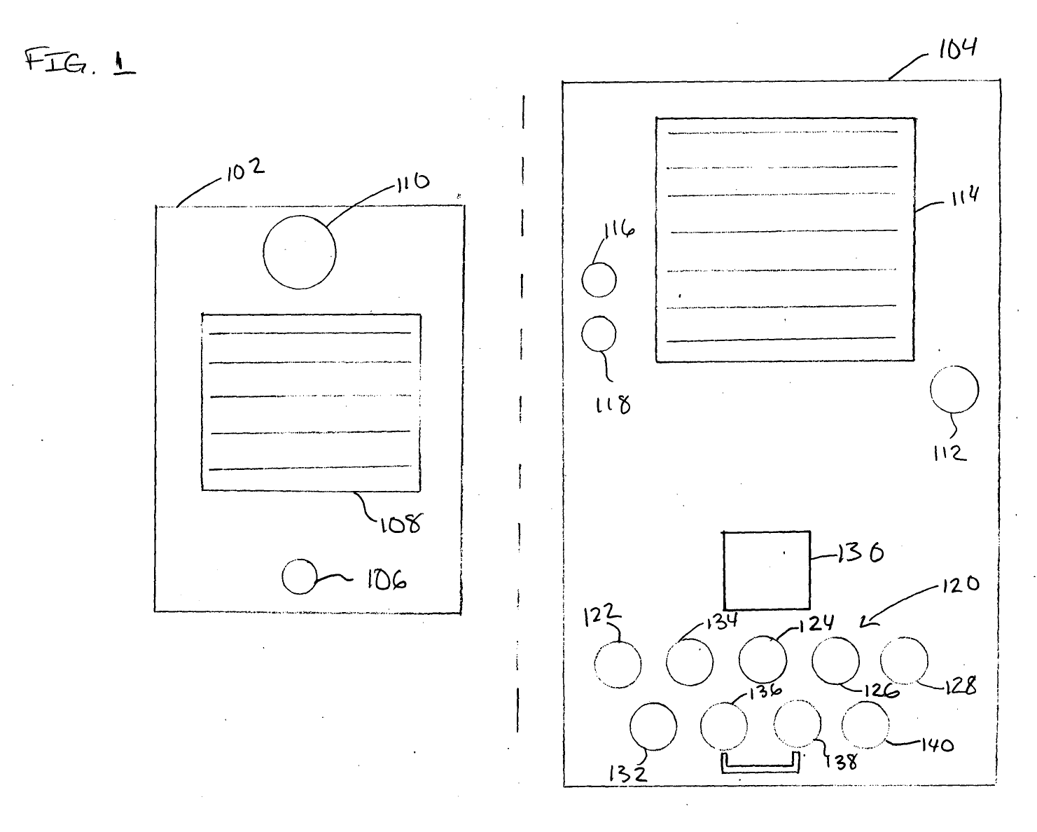

An example doorbell system 100 is shown in FIG. 1 and includes a first, exterior panel 102 and a second, interior panel 104. The exterior panel 102 includes a sensor 106, which in the illustrated example takes the form of a doorbell button. Alternatively, the sensor 106 may be a motion detector or other sensor indicating the presence of a visitor at the panel 102. The panel 102 also includes a speaker box 108 and a safety light 110. The interior panel 104 includes an on/off switch 112, a speaker box 114 and higher/lower volume controls 116 and 118, for controlling the volume of the output from the speaker box 114.

The panel 102 may be positioned on the exterior of any enclosure, for example, proximal to a door of a residence. The interior panel 104 may be positioned on the interior of the enclosure adjacent the exterior panel 102 or any other convenient place within the enclosure. The interior panel 104 may be installed back-to-back to the exterior panel 102 using a simple male/female plug connector. Or, with a variable length electrical harness and male/female plug connector, the interior panel 104 may be located on any surface inside the enclosure. In a further alternative, the panels 102 and 104 may communicate via a wireless link, thereby allowing even greater flexibility in panel placement.

The button 112 is used to turn the system 100 from between an ON state, also termed an automatic answer mode, and an OFF state, also termed a normal mode. In the normal mode, when a visitor depresses the button 106, a doorbell chime is announced on the speakers 108 and 114, and the safety light 110 is turned on to illuminate an area around the panel 102. In the automatic answer mode, when a visitor depresses the button 106, an audible event is announced on the speaker 108—for example, a greeting message prompting the visitor to identify themselves and the nature of their visit. In the automatic answer mode, a visitor may provide a message at the exterior panel 102, and that message is monitored and recorded. Monitoring plays the message on the speaker box 114 of the interior panel 104 to allow a user to immediately know the identity of the visitor and the nature of their visit. The user may then answer the door if they like, ignore the visitor, or initiate a panic feature to ward of the visitor. While the message is being announced on the speaker 114, the message is also recorded for playback later. The button 112 may be switched to a different state at any time, either before, during or after a visitation. For example, the button 112 may be switched from an OFF position to an ON position after a doorbell chime is played, to prompt a visitor to also leave a message.

The interior panel 104 controls operation of the exterior panel 102 by sending audible events, i.e., greeting messages and/or chimes, to the speaker box 108 for announcement. The interior panel 104 also controls numerous other features of the system 100 via control panel 120. To record a message greeting for announcing on the speaker box 108, the panel 104 includes an announce button 122. Once the announce button 122 is depressed and held, the user may speak a message greeting into the speaker box 114, and the message is recorded for subsequent announcement on the exterior panel 102. When the button 122 is released, the message recording stops.

To playback a message recorded from the exterior panel 102, the panel 120 includes a play/pause button 124, a delete button 126, a skip button 128 and a repeat button, which in the illustrated example is also the button 122. For example, when a visual indicator 130 (e.g., a liquid crystal or light emitting diode display) displays an indication that a message has been stored, the user may press the button 124 to play that message. The user may delete the message or replay the message, via buttons 126 and 122, respectively. To replay a message, the button 122 is depressed and immediately released, as opposed to being depressed and held which activates the announce feature of the button 122. If the indicator 130 displays that multiple messages have been stored, then the operator may wish to depress the skip button 128 to move forward to the next stored message. In so doing, the indicator 130 may indicate the current message and/or the current total number of messages stored.

The panel 120 further includes a chime adjustment button 132 that is used to select between different chimes for the panel 102 during normal mode operation. The button 132 may be pressed once to select announcement of the local chime on the speaker box 114, the local chime being the normal doorbell chime, for example. The button 132 may be pressed a second time to select a remote chime, i.e., a unique chime stored by the user or otherwise that is different from the doorbell chime. In this way, a user may set a unique and more pleasant chime to be announced on the speaker box 114, when a visitor arrives during normal mode operation. The chime adjust button 132 may additionally adjust a doorbell chime repeated at the speaker box 108, if the doorbell chime is to be played there.

The control panel 120 also includes a memo button 134 that may be pressed and held to record an internal memo, at the speaker box 114. This internal memo is saved in the system 100 along with any messages recorder from the external panel 102. The internal memo feature may be used for a user to leave a message to another user for playback upon depressing the button 124.

As indicated above, during playback monitoring of a visitor's message, the user may initiate a panic feature to ward off the visitor. In the illustrated example of FIG. 1, two buttons 136, 138 form a manually-controlled actuator. When the buttons 136 and 138 are simultaneously depressed, the interior panel 104 sends a signal to the exterior panel 102 to play a loud audible event, such as a warning alarm or siren. The warning alarm is announced via the speaker box 108. In a preferred example, the warning alarm is loud enough to envelope an area of interest, such as residential block. The warning alarm may include a tone or ringing, with or without voice annunciation for the reason for the alarm. In the preferred example, both buttons 136 and 138 must be depressed so as to avoid unintentional alarm signals. This need not be the case, however.

As mentioned above, buttons on the control panel 120 may have multiple functions. The button 122 functions under a repeat mode, an announcement mode, and a day mode. In the latter mode, the button 128 may be depressed and held, and then when the button 122 is depressed, the panel 104 will cycle through days of week, until the user releases the button 122 corresponding to the current selected day of the week. The days may be announced on the speaker box 114. Similarly, the button 128 may be depressed and held while the button 134 is depressed to select the current hour or while the button 124 is depressed to select the current minute time. The hours and time may be announced on the speaker box 114, during cycling, or indicated at the indicator 130.

To adjust the length of time the safety light 110 is on after the button 106 is depressed, the button 136 may be depressed and held while a timer adjust button 140 is pressed. Pressing the button 140 each time, the user may cycle through 0, 1, 3, and 5 minute intervals. A 0 time turns off the safety light feature. To adjust the length of time the warning alarm is announced, the button 138 may be depressed and held and then the button 140 pressed to cycle through 1, 3, and 5 minute intervals. In either case, the minutes can be announced on the speaker box 114 or displayed on the indicator 130. Of course, these times are by way of example only.

Although various control panel buttons are described, additional or fewer buttons may be used. Furthermore, buttons other than push buttons may be used, for example, slide switches. Further still, while the multiple function buttons are described as operating by depressing and holding a particular button, persons of ordinary skill in the art will appreciate that this is by way of example only, and other button and or switch configurations may be used.

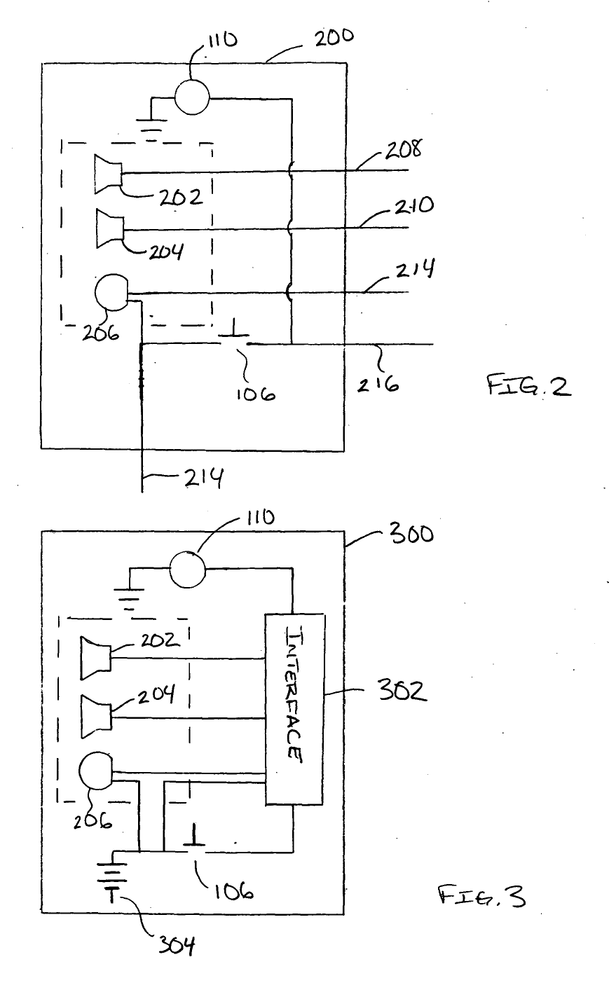

FIG. 2 is an illustration of an example exterior panel 200 that may be hard-wired to an interior panel. The panel 200 includes the safety light 110, a first speaker 202, a second speaker 204 and a microphone 206. The speakers 202, 204 and the microphone 206 form the speaker box 108. The speakers 202 and 204 are directly connected to an interior panel via connections 208 and 210. The speaker 202 may announce the message greeting, and the speaker 204 may announce the warning alarm. The microphone 206 records a message from a visitor and provides that message to the interior panel via connection 212. The button 106 is connected between a power source connection 214 (e.g., a conventional 24 volt doorbell power line) and a connection 216 coupled to the interior panel. The connection 216 is also coupled to power the safety light 110 upon activation of the button 106. The exterior panel 200 may alternatively include an internal battery source in place of the power source connection 214. Further still, the power source connection 214 may be used along with a separate battery source and power fault detector/switch. In the dual configuration, the internal battery may serve either as a backup power source or as a second primary power source.

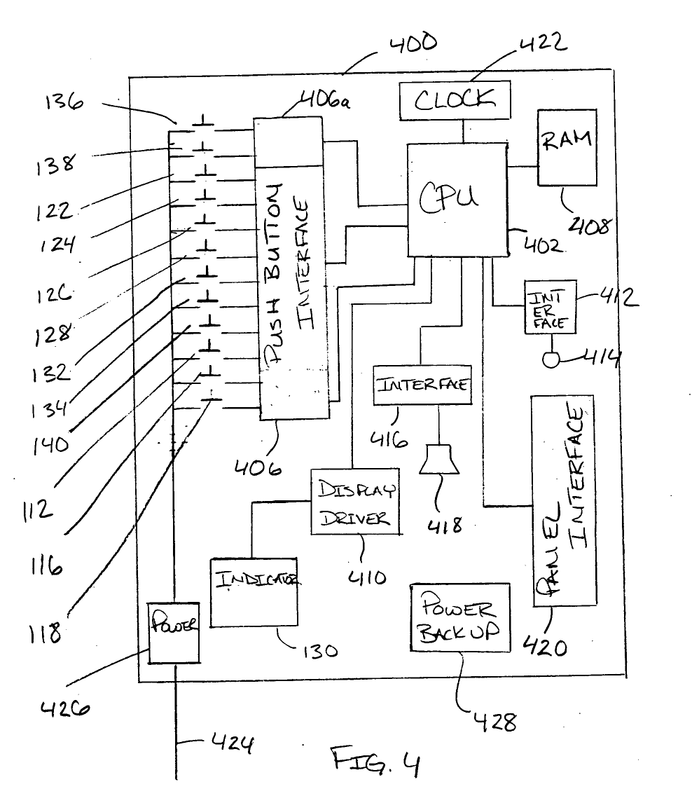

FIG. 3 shows an alternative exterior panel 300 having similar structure to that of panel 200, said similar structure bearing identical reference numbers. In place of the connectors 208, 210, 212, and 216, the panel 300 includes a panel interface 302 that interfaces the exterior panel 300 with an interior panel. The interface 302 may be a wired interface, for example, one allowing multiplexing and demultiplexing of signals to and from the interior panel. Alternatively, in the illustrated example, the panel interface 302 is a transceiver having a wireless communication link with a transceiver associated with the interior panel. In an example implementation, the interface 302 may include control circuitry, a decoder, an encoder, an antenna, and a gain stage. The interface 302 may also include memory for storing audible events to be announced on the speaker box 108. The interface 302 may also control the length of time the light 110 is activated and the length of time the warning alann is announced on speaker 204.

In the illustrated example, the panel 300 includes a separate power source 304, such as an internal battery power source. The power source 304 powers the microphone 206 and the interface 302 at all times. The power source 304 is also coupled to the button 106 so that a signal is sent to the interface 302 when the button is depressed. The interface 302 may control power to the safety light 110. This power configuration is by way of example only. In an alternative to the battery 304, the external power source connection 214 (e.g., a conventional 24 volt doorbell power line) may be used to power the panel 300, or a battery and power source connection combination may be used.

FIG. 4 illustrates an example interior panel 400 that includes a CPU 402 and that may be used as the panel 104. The CPU 402 may be a microprocessor or an application specific integrated circuit (ASIC). The CPU 402 is connected to a push button interface 406 that may comprise control circuitry, a multiplexer and an analog-to-digital converter. The interface 406 provides the CPU 402 with a signal indicating which of the control panel 120, or other buttons on the panel 104, have been depressed. Although a single push button interface 406 may be used, in the illustrated example, the push button interface 406 includes a secondary interface 406a that is coupled to the push buttons 138 and 140 and the CPU 402. The secondary interface 406a may have logic circuitry to determine if a signal button 138 or 140 is depressed or if both buttons are depressed. Alternatively, these determinations may be made in the CPU 402.

The interior panel 400 further includes a memory in the form a random access memory (RAM) memory 408 for storing messages and timing data. The panel 400 further includes a display driver 410 coupled between the CPU 402 and the indicator 130. An interface 412 couples the CPU 402 to a microphone 414. The interface 412 may include logic circuitry, analog-to-digital conversion circuitry, as well as a gain stage. Similarly, a speaker interface 416 couples the CPU 402 to a speaker 418 that is part of the speaker box 114, along with the microphone 414.

The panel 400 also includes a panel interface 420 similar to the panel interface 302 of FIG. 3. In a wireless communication environment, the panel interface 420 may be a transceiver including an antennae, decoder, encoder, gain stage, and control circuitry. Alternatively, the interface 420 may be a hard-wired interface to an exterior panel, such as the panel 200.

The interior panel 400 also includes an internal clock 422 that stores a current date and time. The internal clock 422 may be set via the CPU 402 using buttons 122 and 124, as described above.

In a preferred example, the panel 400 is powered by an external power source, such as a conventional 24 volt doorbell power line in a residence, like line 424. The line 424 is coupled to a power converter/distributor 426 for the entire panel 400. The panel 400 may also include a low voltage replaceable battery backup 428, for example a 9 volt lithium battery. The backup 428 may be useful either in a hard-wired or wireless environment to maintain the time and date on the clock 422 after a power failure. The backup 428 may alternatively be used to power the entire panel 400. An exterior panel hard-wired to the panel 400 may be externally powered by the same 24 volt line powering the panel 400. Further still, the panel 400 could be powered by both an external and internal power source, in either primary/backup or primary/primary configurations.

Although certain apparatus constructed in accordance with the teachings of the invention have been described herein, the scope of coverage of this patent is not limited thereto. On the contrary, this patent covers all embodiments of the teachings of the invention fairly falling within the scope of the appended claims either literally or under the doctrine of equivalence.

What is claimed is:

1. A doorbell apparatus for mounting proximal to a door comprising:
a sensor for generating a signal in response to the presence of an individual at the door;
a first speaker for announcing a first audible event in response to the sensor's signal;
a microphone for receiving a response to the first audible event from the individual;
a playback means for playing the response, the playback means having a monitoring mode and a controlled playback mode;
a storage means for storing the response;
a second speaker for announcing the stored response remotely from the microphone during the monitoring mode; and
a manually-controlled actuator for selectively announcing a second audible event at the first panel, in response to the announcing of the stored response.

2. The doorbell apparatus of claim 1, wherein the second audible event is a warning alarm.

3. The doorbell apparatus of claim 1, wherein the storage means stores multiple responses to the first audible event.

4. The doorbell apparatus of claim 3, wherein the playback means further comprises a playback button, a forward button, and an erase button, for selectively accessing the multiple responses in the controlled playback mode.

5. The doorbell apparatus of claim 3, wherein the playback means includes an indicator indicating the number of responses recorded.

6. The doorbell apparatus of claim 3, wherein the storage means stores an identifier for each of the multiple responses.

7. The doorbell apparatus of claim 6, wherein the identifier is an audible time identifier.

8. The doorbell apparatus claim 1, further comprising:
a first panel including the sensor, the first speaker, and the microphone; and
a second panel including the playback means, the storage means, the second speaker, and the manually-controlled actuator.

9. The doorbell apparatus of claim 8, further comprising a light associated with the first panel, the light being activated in response to the signal from the sensor.

10. The doorbell apparatus of claim 8, wherein the first panel and the second panel are hard-wired to each other.

11. The doorbell apparatus of claim 8, wherein the first panel and the second panel are coupled together via a wireless link.

12. The doorbell apparatus of claim 10, wherein the second panel is powered by a power source for the first panel.

13. The doorbell apparatus of claim 8, wherein the first panel uses an internal power source.

14. The doorbell apparatus of claim 8, wherein the first panel uses an external power source.

15. The doorbell apparatus of claim 8, wherein the first panel further comprises a third speaker for announcing the second audible event, the third speaker having a coverage area large enough to announce the second audible event over an area of interest.

16. The doorbell apparatus of claim 8, wherein the second panel further comprises a microphone for recording the first audible event to be announced by the speaker.

17. The doorbell apparatus of claim 1, wherein the manually-controlled actuator comprises two buttons that are simultaneously depressed for actuation.

18. The doorbell apparatus of claim 1, further comprising a memo record means.
